(19) United States
(12) Patent Application Publication
(10) Pub. No.: US 2006/0152866 A1
(43) Pub. Date: Jul. 13, 2006

(54) System for maintaining fault-type selection during an out-of-step condition

(76) Inventors: Gabriel Benmouyal, Boucherville (CA); Daqing Hou, Boise, ID (US)

Correspondence Address: David M. Mundt;Cook, Alex, McFarron, Cummings & Mehler, Ltd., Suite 2850, 200 West Adams Street, Chicago, IL, 60606, US

(21) Appl. No.: 11/036,863

(22) Filed: Jan. 13, 2005

(51) Int. Cl. H02H 3/00

(52) U.S. Cl. 361/42

(57) ABSTRACT

A system for maintaining fault-type selection during an out-of-step condition is provided comprising an element for calculating the element reach M; an element for fault type selection; an element for out-of-step detection and blocking; and an element for distinguishing between single-phase-to-ground faults and double-phase-to-ground faults. Single-phase-to-ground faults are distinguished from double-phase-to-ground faults through either a derivative or integration element.

### BACKGROUND OF THE INVENTION

The present invention generally relates to a system for maintaining fault-type selection during an out-of-step condition. More specifically, a system for maintaining fault-type selection during an out-of-step condition is provided which compares a calculated fault distance m value to the element reach M; selects fault type; detects and blocks out-of-step conditions; and distinguishes between single-phase-to-ground faults and double-phase-to-ground faults.

Protective relays are generally devices for protecting, monitoring, controlling, metering and/or automating electric power systems and the power transmission lines incorporated therein. In transmission line protective relays, fault-type selection is required particularly in single-pole tripping applications. For single-pole tripping applications, it is necessary to detect a single-phase-to-ground fault without any ambiguity in order to remove the faulted phase from the power network. In situations where protective relays detect a multi-phase fault (e.g. double-phase-to-ground faults) instead of the single-phase fault, three-pole tripping occurs and may jeopardize the single-pole tripping requirement.

A power swing is one situation in which protective relays detect multi-phase faults and which may thereupon jeopardize the single-pole tripping requirement. A power swing on a power network is a balanced condition whereupon the angle between two equivalent sources behind transmission line extremities undergoes a slow variation.

Therefore, it is an aspect and object of this invention to provide a system for maintaining proper fault type selection during an out-of-step condition.

It is further an object of this invention to provide a system for maintaining proper fault type selection during a power swing.

It is further an object of this invention to provide a system for maintaining proper fault type selection even when the angle between two equivalent sources behind transmission line extremities undergoes a slow variation.

These and other desired benefits of the preferred embodiments, including combinations of features thereof, of the invention will become apparent from the following description. It will be understood, however, that a process or arrangement could still appropriate the claimed invention without accomplishing each and every one of these desired benefits, including those gleaned from the following description. The appended claims, not these desired benefits, define the subject matter of the invention. Any and all benefits are derived from the multiple embodiments of the invention, not necessarily the invention in general.

### SUMMARY OF THE INVENTION

In view of the desired goals of the invention specified herein, a system for maintaining fault-type selection during an out-of-step condition is provided which compares a calculated fault distance m value to the element reach M; selects fault type; detects and blocks out-of-step conditions; and distinguishes between single-phase-to-ground faults and double-phase-to-ground faults.

More specifically, the system compares a calculated fault distance m value to the element reach M. In yet another embodiment, the system may ascertain M values for more than one zone. In the multiple zone embodiment, the signals from zone 1 and zone 2 are “ORed” to latch proper m values.

Blocking signals which block the subsequent mho detector tripping signal are further detected. If there are no out-of-step blocking signals detected, the fault-type selection element then determines the resulting faulted phase(s). If there are out-of-step blocking signals detected, the fault-type selection element then determines the phase angle plane of the resultant signal. The system then distinguishes the resulting outputs provided by the fault-type selection element.

In distinguishing between single-phase-to-ground faults and double-phase-to-ground faults, an element is provided which monitors the rate of change of the apparent impedance, and the faulted impedance loop having the least rate of change may be isolated. The time-derivative or the rate-of-change of the apparent impedance in the complex plane is computed.

In yet another embodiment for distinguishing between single-phase-to-ground faults and double-phase-to-ground faults, an element is provided which determines and integrates the difference between the calculated fault distance m value and a latched m value for each loop. The difference between these two integrals output values is then compared to a selected negative threshold and a selected positive threshold. A single-phase-to-ground fault is asserted if the difference between the two integrals output values reaches the negative threshold, whereas a double-phase-to-ground fault occurs if the difference between the two integrals output values reaches a positive threshold.

It should be understood that the present invention includes a number of different aspects or features which may have utility alone and/or in combination with other aspects or features. Accordingly, this summary is not exhaustive identification of each such aspect or feature that is now or may hereafter be claimed, but represents an overview of certain aspects of the present invention to assist in understanding the more detailed description that follows. The scope of the invention is not limited to the specific embodiments described below, but is set forth in the claims now or hereafter filed.

### BRIEF DESCRIPTION OF THE SEVERAL VIEWS OF THE DRAWINGS

FIG. 1 illustrates a circuit diagram of a power system comprising three-phase voltage source.

FIG. 2 is a graphical representation of an out-of-step detection and blocking element of the one of the various embodiments in accordance with the teachings of the present invention.

FIG. 3 is a graphical representation of the characteristics of the m values for an mbg and mcaf trajectory used in the system element for discriminating between single-phase-to-ground faults and double-phase-to-ground faults in accordance with the teachings of the present invention.

FIG. 4 is a graphical representation of the integration of the FIG. 3 m values for use in the system element for distinguishing between single-phase-to-ground faults and double-phase-to-ground faults in accordance with the teachings of the present invention.

FIG. 5 illustrates a general logic diagram for using conventional methods and elements for comparing a calculated fault distance m value to the element reach M; selecting fault type; and detecting and blocking out-of-step conditions with the present invention system for distinguishing between single-phase-to-ground faults and double-phase-to-ground faults.

FIG. 6 illustrates a schematic diagram of one embodiment of the present invention fault-type selection during power swing element of FIG. 5 for distinguishing between a phase A-to-ground fault and a phase B-to-C fault for corresponding zone 1 mho elements using a derivative element.

FIG. 7 illustrates schematic diagram of yet another embodiment of the present invention fault-type selection during power swing element of FIG. 5 for distinguishing between a phase A-to-ground fault and a phase B-to-C fault for corresponding zone 1 mho elements using an integrator.

FIG. 8 illustrates a schematic diagram of yet another embodiment of the present invention fault-type selection during power swing element of FIG. 5 for distinguishing between multiple zone mho elements using an integrator and a fault detector.

### DETAILED DESCRIPTION OF THE PREFERRED EMBODIMENTS

Generally, system control or protective devices are used for protecting, monitoring, controlling, metering and/or automating electric power systems and associated transmission lines. These system control or protective devices may include protective relays, RTUs, PLCs, bay controllers, SCADA systems, general computer systems, meters, and any other comparable devices used for protecting, monitoring, controlling, metering and/or automating electric power systems and their associated transmission lines.

Although embodiments described herein are preferably implemented in protective relays, it is contemplated that the embodiments may also be implemented in any suitable system control or protective devices such as those described above.

The various embodiments of the invention generally comprises four elements which respectively compares a calculated fault distance m value to the element reach M; selects fault type; detects and blocks out-of-step conditions; and distinguishes between single-phase-to-ground faults and double-phase-to-ground faults. In comparing a calculated fault distance m value to the element reach M; selecting fault type; and detecting and blocking out-of-step conditions, conventional methods and/or elements known in the art have been described herein. Nevertheless, other conventional methods known in the art for comparing a calculated fault distance m value to the element reach M; selecting fault type; and detecting and blocking out-of-step conditions may be used in accordance with the present invention as described herein.

A. Comparison of the Calculated Fault Distance m Value to the Element Reach M

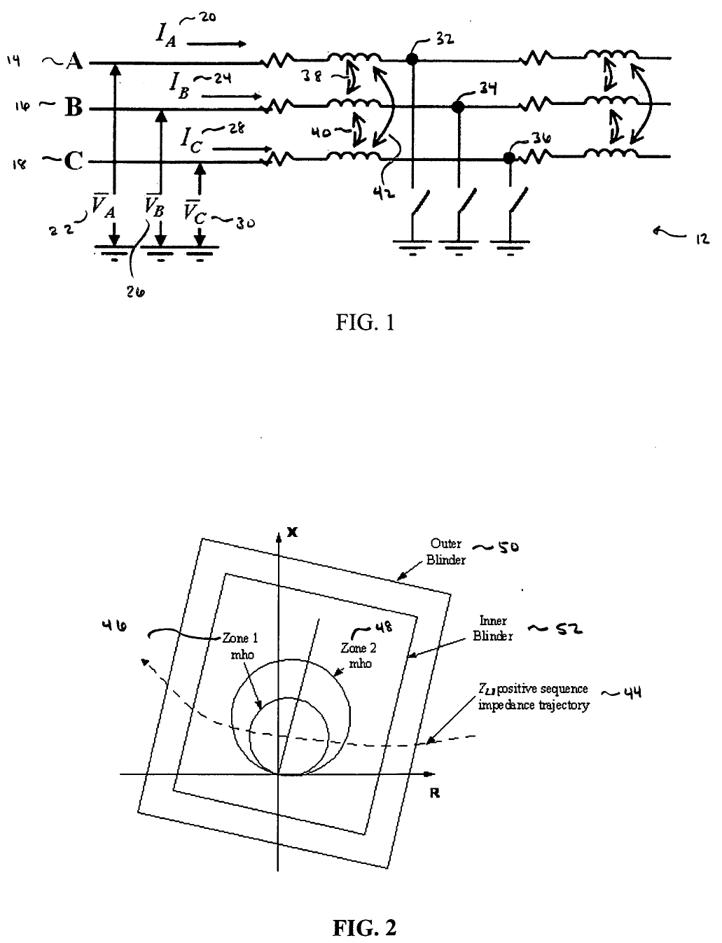

FIG. 1 illustrates a circuit diagram of a power system 12 comprising a three-phase voltage source. In measuring various circuit values for the power system 12, a transmission line distance based relay is typically associated with all three phases A 14, B 16, C 18. For example, the relay may measure the current (I_{A}) 20 and the voltage (VA) 22 of phase A 14. Moreover, the relay may measure the current (I_{B}) 24 and the voltage (V_{B}) 26 of phase B 16 and the current (I_{C}) 28 and the voltage (V_{C}) 30 of phase C 18. An example of such a transmission line distance based relay includes the SEL-421 High-Speed Line Protection, Automation, and Control System manufactured by Schweitzer Engineering Laboratories, Inc.

This power system 12 further includes various fault types including phase A-to-ground (AG) 32; phase B-to-ground (BG) 34; phase C-to-ground (CG) 36; phase A-to-B 38 or A-to-B-to-ground (both AB); phase B-to-C 40 or B-to-C-to-ground (both BC); and phase C-to-A 42 or C-to-A-to-ground (both CA).

In order to cover all possible faults in a power system 12 as shown in FIG. 1, the relay comprises six mho element, each covering a particular impedance loop. Each of these mho measurement loops are defined by an operating and polarizing vector derived from Equation 1 and 2.
Sₒₚ=M·Z_{L1}I_{R}−V_{R} Equation 1
Sₚₒₗ=Vₚₒₗ Equation 2

In equation 1, Sₒₚ represents the operating vector. M represents the mho element reach in per unit value of the line length. This M value is also commonly referred to as the zone of protection. In Equation 1, Z_{L1} further represents the impedance of the line. I_{R} represents the current supplied to the mho element for a particular impedance loop; and V_{R} represents the voltage supplied to the mho element for a particular impedance loop. In this case, Z_{L1} may be a positive sequence value, and V_{R} and I_{R} may be phasor values. In equation 2, Sₚₒₗ represents the polarizing vector, and Vₚₒₗ represents the polarizing voltage phasor.

Referring specifically to the V_{R} and I_{R} expressions of Equation 1, Table 1 shows the expressions of V_{R} and I_{R} for the six impedance loops in accordance with Equation 1. In this table, I_{A} 20, I_{B} 24, and I_{C} 28 represent phase currents at each relay location, whereas V_{A} 22, V_{B}-26, and V_{C} 30 represents phase voltages at each relay location. K_{oL} in Table 1 represents the zero sequence line compensating factor and may be defined by Equation 4. In equation 4, Z_{L0} further represents zero sequence line impedance and Z_{L1} represents positive sequence line impedance. I_{O} represents the zero sequence current at the relay location and may be defined by Equation 3.

TABLE 1
Impedance loops supplied voltages and currents
$Equation 3 \text{:} {I}_{O} = \frac{1}{3} ( {I}_{A} + {I}_{B} + {I}_{C} )$
$Equation 4 \text{:} {K}_{OL} = \frac{{Z}_{L 0} - {Z}_{L 1}}{3 {Z}_{L 1}}$

| Fault Type | V_{R} | I_{R} |
|---|---|---|
| AG | V_{A} | I_{A} + K_{0L}I₀ |
| BG | V_{B} | I_{B} + K_{0L}I₀ |
| CG | V_{C} | I_{C} + K_{0L}I₀ |
| AB | V_{A}-V_{B} | I_{A}-I_{B} |
| BC | V_{B}-V_{C} | I_{B}-I_{C} |
| CA | V_{C}-V_{A} | I_{C}-I_{A} |

With the expressions of V_{R} and I_{R} as derived in Table 1, the apparent impedance, Zₐₚ, of a particular impedance loop may be defined as shown in Equation 5.

$$Equation 5 \text{:}$$

$${Z}_{ap} = \frac{{V}_{R}}{{I}_{R}}$$

Now referring specifically to the M expression from Equation 1, this element reach M expression is further known as the zone of protection. For example, where M=0.8 to 0.9 a particular zone (i.e. Zone 1) may cover 80% to 90% of the line. In this same example, Zone 2 may cover 110% to 130% of the line where M=1.1 to 1.3. With this in mind, in order to establish whether a fault exists within an element reach M from the relay, the inequality represented by Equation 6c, which is derived from Equations 6a and 6b, is tested for a particular impedance loop. In Equations 6a, 6b, and 6c, Vₚₒₗ* represents the complex conjugate of the vector quantity Vₚₒₗ.

Equation 6
real(M·Z_{L1}·I_{R}−V_{R})·Vpol*)≧0 (a)
real(M·Z_{L1}I_{R}·Vpol*)−real(V_{R}·Vpol*)≧0 (b)
M·real(Z_{L1}·I_{R}·Vpol*)≧real(V_{R}Vpol*) (c)

From Equation 6, the element reach M may be derived as expressed in two conditions as shown in Equations 7a and 7b. For example, Equation 7a may represent a forward protection zone, wherein both inequalities of Equation 7a must be satisfied for forward protection. On the other hand, Equation 7b may represent reverse protection, wherein both inequalities of Equation 7b must be satisfied for reverse protection.

$$\begin{matrix}Equation 7 \text{:} & \\ M \geq \frac{real ( {V}_{R} \cdot {V}_{pol}^{*} )}{real ( {Z}_{L 1} \cdot {I}_{R} \cdot {V}_{pol}^{⋆} )} if real ( {Z}_{L 1} \cdot {I}_{R} \cdot {V}_{pol}^{*} ) > 0 & ( a ) \\ M \leq \frac{real ( {V}_{R} \cdot {V}_{pol}^{*} )}{real ( {Z}_{L 1} \cdot {I}_{R} \cdot {V}_{pol}^{⋆} )} if real ( {Z}_{L 1} \cdot {I}_{R} \cdot {V}_{pol}^{*} ) < 0 & ( b )\end{matrix}$$

Equation 8 represents the m value. The m value is the calculated fault distance for the particular impedance loop. The m value is compared to the element reach M inequalities to determine faults in either the forward or reverse protection zones. For example, in order to detect a fault in the forward protection zone set at 85%, m<0.85 and real(Z_{L1}·I_{R}·Vₚₒₗ*)>0.

$$Equation 8 \text{:}$$

$$m = \frac{real ( {V}_{R} \cdot {V}_{{pol}^{*}} )}{real ( {Z}_{L 1} \cdot {I}_{R} \cdot {V}_{{pol}^{*}} )}$$

In the remainder of the specification, mag, mbg, mcg, mab, mbc, and mca will designate the calculated phase distance m value with respect to the six conventional loops. Moreover, MAG1, MAG2, and MAG3 will respectively designate zone 1, zone 2, and zone 3 mho impedance element logic state (“0” or “1”) relative to the Phase A-to-ground impedance loop, wherein “0” represents no fault while “1” represents a fault. The same will be applicable to the five other impedance loops. In the various embodiments of the present invention, these values are determined by fault detectors which include distance value computation elements as discussed in detail below although other equivalent means may be used.

B. Fault-Type Selection

Fault type selection is based upon the phase angle difference between negative-sequence and zero-sequence currents. For example, distance relays may achieve fault-type selection through phase angle differences. More specifically, in determining phase angle difference between negative-sequence and zero-sequence currents, the protective relay divides the phase angle plane into three regions. For example, the protective relay may divide the phase angle plane from −60° to 60° for the A-phase region, 60° to 180° for the B-phase region, and −60° to −180° for the C-phase angle.

The protective relay further generally comprises a fault-type selection logic which asserts a particular fault type corresponding with the region in which the phase angle difference between negative-sequence and zero-sequence currents lies. For example, if the phase angle difference lies in the −60° and 60° region, the fault-type selection logic would indicate the selection of the A-phase region. For example, the fault-type selection logic may assert a logic function such as “FSA” if an A-phase region is detected. Alternatively, “FSB” or “FSC” may be asserted for detection of a phase B-to-ground or a phase-C-to ground fault respectively.

Nevertheless, during a normal condition, it is important to note that an FSA assertion may represent not only an A-phase ground fault but also a BC-two-phase ground fault. With this in mind, logic for distinguishing between these two possibilities may be implemented by processing both A-phase-to-ground distance and BC phase distance elements. In this case, for a fault in normal conditions where a system is not out-of-step, only one of the distance elements will give an output and allow the relay to trip correctly. It is also important to note that FSB and FSC assertions may also represent corresponding double-phase-to-ground faults. More specifically, FSB may represent a phase C-to-A double phase-to-ground fault and FSC may represent a phase A-to-B double phase-to-ground fault. In the various embodiments of the present invention, these assertions are determined by phase detection fault-type selection elements as discussed in detail below although other equivalent means may be used.

C. Power Swing Detector for Out-of-Step Detection and Blocking

During power swings, the positive sequence impedance computed on the transmission line relays installed at the two extremities of the line will travel in a complex plane, as shown in FIG. 2. Where this positive sequence impedance trajectory 44 crosses different zones (i.e. Zone 1 designated by 46 or Zone 2 designated by 48), conditions develop where the impedance (mho) detectors associated with the phase faults detect a fault and cause the relay to issue a tripping signal.

In order to detect a power swing or out-of-step condition, the time it takes for the positive sequence impedance to cross the distance between two blinders may be monitored. When the interval of time is greater than a pre-set delay, an out-of step condition is detected. For example, a power swing is detected by monitoring the time for the positive sequence impedance to cross from outer blinder 50 to inner blinder 52. If this time interval is greater than a selected time delay, an out-of-step condition is detected. In the various embodiments of the present invention, out-of-step conditions are determined by out-of-step detection elements as discussed in detail below although other equivalent means may be used.

When an out-of-step condition is detected, the subsequent phase mho detector tripping signal is blocked by supervising these same tripping signals by a blocking signal. Generally, this blocking signal may be associated with each of the zones implemented in the transmission line protection scheme.

In the remainder of the specification, OSB1, OSB2, OSB3 will be used to represent the blocking signal associated with zone 1, zone 2, and zone 3 detectors, respectively. In the various embodiments of the present invention, blocking signals are determined by out-of-step blocking elements as discussed in detail below although other equivalent means may be used.

D. Distinguishing Between Single-Phase-To-Ground Faults and Double-Phase-To-Ground Faults

While using conventional relays during an out-of-step condition or a power swing condition, the fault-type selection could become inoperative if a single-phase-to-ground occurs. For example, in a normal situation, the fault-type selection logic of conventional relays will assert FSA for a zone 1 phase A-to-ground fault. Moreover, the mho logic element will assert MAG1 for zone 1 while the MBC1 will stay at logical state “0”. In this manner, only single-pole tripping of phase A will normally occur if required. During a power swing situation, for the example above, FSA and MAG1 will assert but MBC1 will assert also, thereby causing a possible three-pole trip. In this case, only single-pole tripping is required. This problem may further arise with zone 2 or even zone 3 elements. Therefore, some conventional relays cannot maintain proper fault type selection during an out-of-step condition.

A first embodiment system is contemplated for maintaining proper fault type selection during an out-of-step condition. During out-of step conditions, the apparent impedance (Zₐₚ) as provided by each of the six impedance loops travels in the complex plane at a rate dependent on the out-of-step characteristics. This apparent impedance (Zₐₚ) value is represented by Equation 5 as discussed in more detail above. In this case, if a fault occurs during the out-of-step condition, the corresponding apparent trajectory becomes still in the complex plane. The rate of change of the apparent impedance is monitored, and the faulted impedance loop having the least rate of change is isolated. The derivative of the calculated distance m traveled by the impedance in a complex plane is then computed to distinguish between single-phase-to-ground faults and double-phase-to-ground faults. This m trajectory may also be referred to as a fault distance trajectory. Nevertheless, it is important to note that computing the derivative of the function representing the distance traveled by the impedance in the complex plane amplifies the noise associated therewith. Therefore, this noise is compensated for before measuring the rate of change.

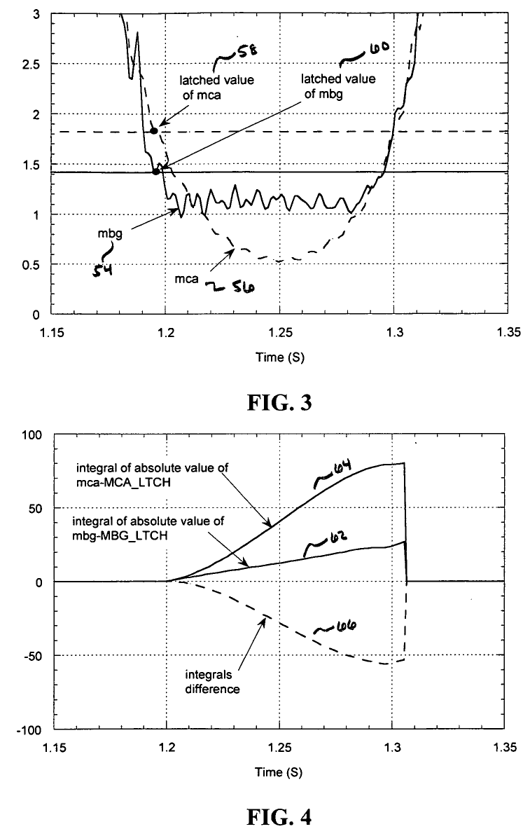

A second embodiment using an integrator is further contemplated as shown in FIGS. 3 through 5. FIG. 3 illustrates the m values for a phase B-to-ground fault loop and a phase C-to-A loop during an out-of-step situation. The corresponding m value for the phase B-to-ground fault loop is designated by mbg 54. As illustrated by FIG. 3, during out-of-step situations, mbg 54 settles to a generally constant value to which a small noise component could be included. The corresponding m value for the phase C-to-A loop is as designated by mca 56. As illustrated by FIG. 3, during out-of-step situations, mca 56 keeps moving and will cause either the zone 1 or zone 2 mho elements to pick up during a single-phase-to-ground fault.

The characteristics of the m values as illustrated in FIG. 3 may be further utilized to eliminate the amplification of noise as discussed with the first embodiment. Theoretically, the m trajectory corresponding to the faulted loop should ideally settle to a constant value equal to the distance to the fault. This m trajectory may also be referred to as a fault distance trajectory. For instance, mbg 54 in FIG. 3 is settling to a constant average value whereas mca 56 keeps moving. Therefore, the derivative as taught in the first embodiment may be replaced with an integration whereupon, the area between the alleged constant m value and the real m trajectory value of mbg is integrated. Because mbg 54 should settle to a constant value, the result of the integration should be zero. As for mca 56, because it does not settle to a constant value, the result of the integration should take a significant magnitude. It is important to note that this same rationale may be applied to the six impedance loops. If the level of the six integrals corresponding to the six impedance loops, the faulted phases should correspond to the integral equaling to zero.

Because the m value or the distance to the fault is not known before the fault occurs, the m value is latched at the moment the zone 1 or zone 2 corresponding mho element picks up. This m value is further latched at the rising edge of the detected fault as shown in FIG. 3. It is important to latch the m value at the rising edge of the detected fault in order to ensure that the zone 1 or zone 2 corresponding mho element picks up. For example, as shown in FIG. 3, the latched value for mca is designated at 58 whereas the latched value of mbg is designated at 60 where the zone 2 mho element picks up. These values are used in an integration as illustrated in FIG. 4. As shown in FIG. 4, the absolute value of the difference between the calculated mbg trajectory 54 and the mbg latched value 60 and the absolute value of the difference between the calculated mca trajectory 56 and the mca latched value 58 are integrated as illustrated in FIG. 4. As shown in FIG. 4, the integration corresponding to the phase B-to-ground (mbg) impedance loop 62 appears smaller than the integration corresponding to the phase C-to-A (mca) impedance loop 64.

In order to ascertain a single-phase-to-ground fault as compared to a double-phase-to-ground fault, the difference of the two integrals corresponding to the two impedance loops is compared to a selected negative and positive threshold. More specifically, a single-phase-to-ground fault occurs if the difference between these two integrals reaches the negative threshold, whereas a double-phase-to-ground fault occurs if the difference between these two integrals reaches the positive threshold. For example, in FIG. 4, the difference between the two integrals corresponding to the mca loop 64 and the mbg loop 62 is ascertained. Because the difference between the two integrals is negative, as shown in FIG. 4 at 66, it is determined that a single-phase-to-ground fault has occurred.

E. General Logic Diagrams

FIG. 5 illustrates a general logic diagram for using conventional methods and elements for comparing a calculated fault distance m value to the element reach M; selecting fault type; and detecting and blocking out-of-step conditions with the present invention system for distinguishing between single-phase-to-ground faults and double-phase-to-ground faults. This system logic may be hard wired into a protective device circuit board or even inputted or programmed into the protective device using system software or other equivalent means. The protective device is preferably a protective relay which may be connected to the system as described above in conjunction with FIG. 1.

More specifically, six mho type fault detectors 68 use input system voltage (V_{A} 22, V_{B} 26, and V_{C} 30 from FIG. 1) and current values (I_{A} 20, I_{B} 24, and I_{C} 28 from FIG. 1), collectively shown at 70 including a distance value computation element, to ascertain a calculated fault distance m value and the element reach M. The resulting output values from the six mho type fault detectors 68 are the element reach M values (MAG1, MAG2, MBG1, MBG2, MCG1, MCG2, MAB1, MAB2, MBC1, MBC2, MCA1, MCA2, collectively shown at 72) and the calculated fault distance m value mag, mbg, mcg, mab, mbc, mca, collectively shown at 74) as described in one of the methods above. The fault detectors 68 further detect whether a fault is in either a forward or reverse protection zone.

A phase detection fault-type selection element 76 is shown using input I_{O} and I₂ values (collectively shown at 78) to ascertain FSA, FSB, or FSC (collectively shown at 80) fault type assertions as described in one conventional method above. A power swing detector 82 including an out-of-step detection element and an out-of-step locking element for out-of-step detection and blocking is further shown using an input Z_{L1} value 84 to provide blocking signals (OSB1, OSB2), collectively shown at 86 as described in one conventional method above.

The output values from the mho type fault detectors 68, phase detection fault-type selection element 76, and power swing detector 82 are used by the present invention power swing fault-type selection element 88 for distinguishing between single-phase-to-ground faults and double-phase-to-ground faults. More specifically, the power swing fault-type selection element 88 provides output signals 90 to an associated relay for distinguishing between single-phase-to-ground faults and double-phase-to-ground faults.

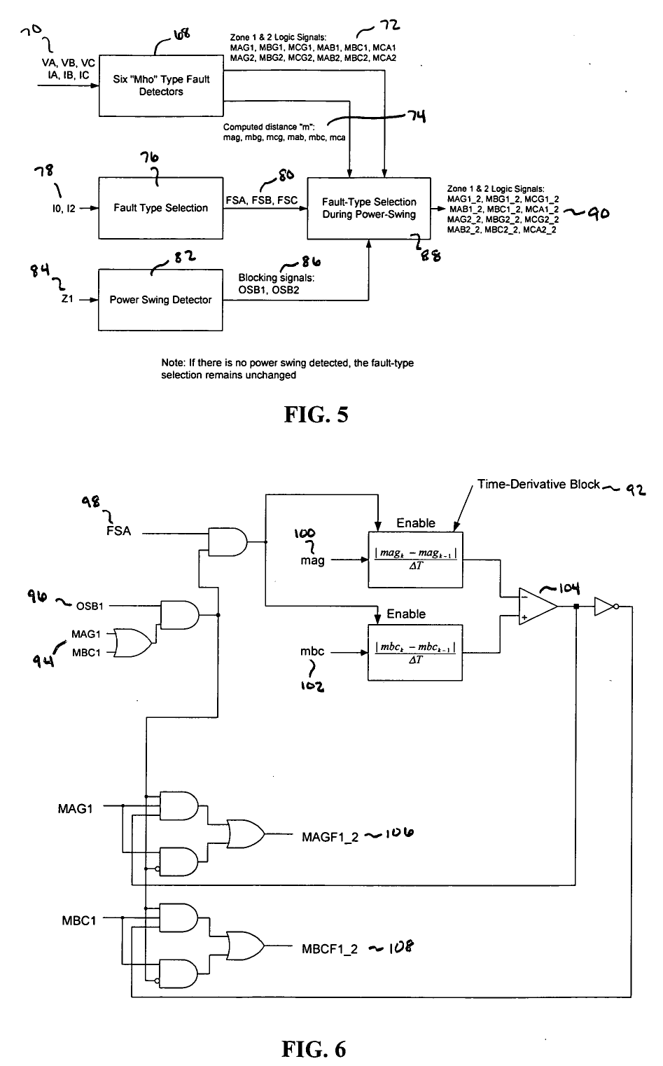

FIG. 6 illustrates a general logic diagram for one embodiment for distinguishing between a phase A-to-ground fault and a phase B-to-C fault for the corresponding zone 1 mho elements using a derivative element 92. As shown in FIG. 6, the MAG1 and MBC1 values for zone 1 mho elements are ascertained at 94 through the teachings of Equation 7. Blocking signals which block the subsequent mho detector tripping signal are detected as designated at 96 by an out-of-step blocking element, such as in the power swing detector 82 as shown in FIG. 5.

If there are no out-of-step blocking signals detected, whereupon OSB1=0, no modification is brought up to the mho element outputs. If there are out-of-step blocking signals detected, whereupon OSB1=1, a phase detection fault-type selection element then determines the faulted phase. For example, as illustrated in FIG. 6, the A-phase region is detected, thereby causing an assertion of FSA as designated at 98. Nevertheless, as discussed above with regard to fault type selection, when FSA is asserted, it could further indicate that a BC two-phase ground fault may be present as well. Accordingly, the system must then distinguish the resulting outputs provided by the fault-type selection element.

In order to distinguish between the two possibilities, a power swing fault type selection element is provided including a distance value computation element for determining mag 100 and mbc 102 values. The absolute value of the derivatives of mag 100 and mbc 102 values are taken over a determined time T as shown at block 92. The absolute value of the derivative of mag 100 is then compared to the absolute value of the derivative of mbc 102 at comparator 104. For example, a single-phase-to-ground fault signal is asserted if the absolute value of the derivative of mag 100 is smaller than the absolute value of derivative of mbc 102, whereas a double-phase-to-ground fault signal is asserted if the absolute value of the derivative of mbc 102 is smaller than the absolute value of the derivative of mag 100.

In this case, MAGF1_2 106 and MBCF1_2 108 represent the final state for the zone 1 mho elements after proper fault type has been selected.

It should be understood that this same logic is applicable to other impedance loops as well; for example, in the determination between phase B-to-ground and phase C-to-A impedance loops and in the determination between phase C-to-ground and phase A-to-B impedance loops.

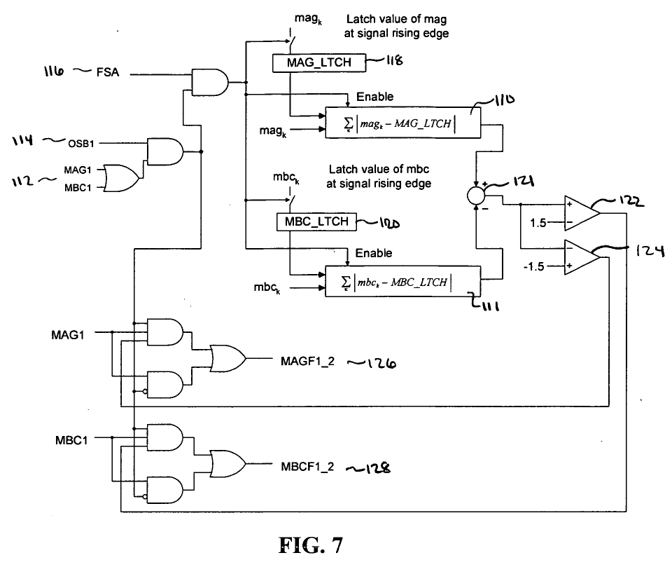

FIG. 7 illustrates a general logic diagram of another embodiment of the present invention for distinguishing between a phase A-to-ground fault and a phase B-to-C fault for the corresponding zone 1 mho elements using an integrator 110, 111. As shown in FIG. 7, the MAG1 and MBC1 values for zone 1 mho elements are ascertained at 112 through the teachings of Equation 7. Blocking signals which block the subsequent mho detector tripping signal are detected as designated at 114 by an out-of-step blocking element.

If there are no out-of-step blocking signals detected, whereupon OSB1=0, no modification is brought up to the mho element outputs. If there are out-of-step blocking signals detected, whereupon OSB1=1, a phase detection fault-type selection element then determines the resulting signal from the phase angle between I0 and I2.

For example, as illustrated in FIG. 7, the A-phase is detected, thereby causing an assertion of FSA as designated at 116. Nevertheless, as discussed above with regard to fault type selection, when FSA is asserted, it could further indicate that a BC two-phase ground fault may be present as well. Accordingly, the system must then distinguish the resulting outputs provided by the fault-type selection element.

In order to distinguish between the two possibilities, a power swing fault type selection element is provided. Latched m values are determined as described in more detail with respect to FIGS. 3-4. In FIG. 7, the latched mag and mbc values are determined at the rising edge of the detected fault and as soon as one of the zone 1 mho elements picks up by a distance value computation element such as that shown in FIG. 5. It is important to latch the m value at the rising edge of the detected fault in order to ensure that the zone 1 mho element picks up. The determination of latched value for mag or MAG_LTCH is represented at 118 while the latched value determination for mbc is represented by MBC_LTCH at 120. The absolute value of the difference between the mag trajectory and the MAG_LTCH value is integrated at 110 and the difference between the mbc trajectory and the MBC_LTCH value is integrated at 111 using a first and second integrator. The difference between the two integrals is calculated at 121 by a subtraction element and then compared to a selected negative threshold 124 and a selected positive threshold 122. In this case, a threshold of 1.5 is selected. It is important to note that any other positive or negative threshold may be utilized. Therefore, a single-phase-to-ground fault is asserted if the difference between the two integrals reaches −1.5, whereas a double-phase-to-ground fault occurs if the same difference reaches +1.5.

In this case, MAGF1_2 126 and MBCF1_2 128 represent the final state for the zone 1 mho elements after proper fault type has been selected.

It should be understood that this same logic is applicable to other impedance loops as well; for example, in the determination between phase B-to-ground and phase C-to-A impedance loops and in the determination between phase C-to-ground and phase A-to-B impedance loops.

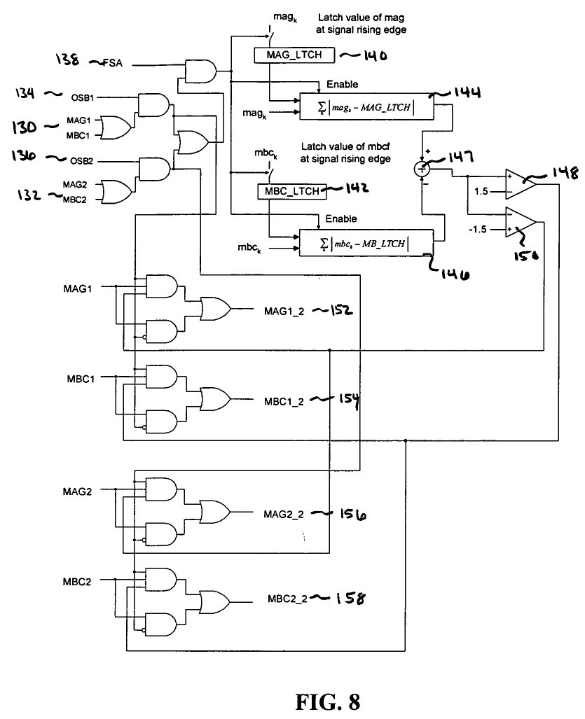

Moreover, the same logic can cover more than one zone (e.g. both forward and reverse protection zones). FIG. 8 illustrates the consideration of both zone 1 and zone 2 by using the same integrated values. In this case, the signals from zone 1 and zone 2 are “ORed” to latch proper m values. In FIG. 8, MAG1 and MBC1 are “ORed” as designated at 130 while MAG2 and MBC2 are “ORed” as designated at 132.

After one of the two MAG and MBC is selected by a fault detector, blocking signals which block the subsequent mho detector tripping signal are detected as designated at 134, 136 by an out-of-step blocking element. If there are no out-of-step blocking signals detected, whereupon OSB1=0, no modification is brought up to the mho element outputs. If there are out-of-step blocking signals detected, whereupon OSB1=1, a phase detection fault-type selection element then determines the resultant signal and and asserts FSA as designated at 138.

In order to distinguish between the two possibilities, a power swing fault type selection element is provided. Latched m values are determined as described in more detail with respect to FIGS. 3-4. In FIG. 8, the latched mag and mbc values are determined at the rising edge of the detected fault and as soon as one of the mho elements picks up. It is important to latch the m value at the rising edge of the detected fault in order to ensure that the mho element picks up. The determination of latch value for mag or MAG_LTCH is represented at 140 while the latch value determination for mbc or MBC_LTCH is represented at 142.

The absolute value of the difference between the mag trajectory and MAG_LTCH is integrated as shown at 144 by an integrator. The absolute value of the difference between the mbc trajectory and MBC_LTCH is integrated as shown at 146 by another integrator. The difference between the two integrals is calculated at 147 by a subtraction element and then compared to a selected negative threshold 148 and a selected positive threshold 150. In this case, a threshold of 1.5 is selected. It is important to note that any other positive or negative threshold may be utilized. Therefore, a single-phase-to-ground fault signal is asserted if the difference between the two integrals reaches −1.5, whereas a double-phase-to-ground fault signal is asserted if the difference between the two integrals reaches +1.5.

In this case, MAG1_2 152, MBC1_2 154, MAG2_2 156, and MBC2_2 158 represent the final state for the mho elements after proper fault type has been selected.

Similar system logic to that of FIG. 8 may be used for the consideration of both zone 1 and zone 2 by using the derivative values as shown in FIG. 6.

While this invention has been described with reference to certain illustrative aspects, it will be understood that this description shall not be construed in a limiting sense. Rather, various changes and modifications can be made to the illustrative embodiments without departing from the true spirit, central characteristics and scope of the invention, including those combinations of features that are individually disclosed or claimed herein. Furthermore, it will be appreciated that any such changes and modifications will be recognized by those skilled in the art as an equivalent to one or more elements of the following claims, and shall be covered by such claims to the fullest extent permitted by law.

1. A system for distinguishing between a single-phase-to-ground fault and a double-phase-to-ground fault, comprising:
a distance value computation element for determining a first distance value for a first fault distance trajectory and a second distance value for a second fault distance trajectory,
a power swing fault-type selection element including a first integrator for determining an integral value of the difference between a first latched value of the distance value and the first fault distance trajectory, wherein the first latched value is determined at a rising edge of a detected fault, and a second integrator for determining an integral value of the difference between a second latched value of the distance value and the second fault distance trajectory, wherein the second latched value is determined at a rising edge of a detected fault.

2. The system for distinguishing between a single-phase-to-ground fault and a double-phase-to-ground fault of claim 1, further comprising an out-of-step detection element in communicating relation with the power swing fault-type selection element for detecting an out-of-step condition.

3. The system for distinguishing between a single-phase-to-ground fault and a double-phase-to-ground fault of claim 1, further comprising an out-of-step blocking element in communicating relation with the power swing fault-type selection element for blocking a tripping signal.

4. The system for distinguishing between a single-phase-to-ground fault and a double-phase-to-ground fault of claim 1, further comprising a fault detector in communicating relation with said power swing fault-type selection element for detecting whether a fault is in either a forward or reverse protection zone.

5. The system for distinguishing between a single-phase-to-ground fault and a double-phase-to-ground fault of claim 4, wherein the fault detector is a mho type fault detector.

6. The system for distinguishing between a single-phase-to-ground fault and a double-phase-to-ground fault of claim 2, further comprising a fault detector in communicating relation with said out-of-step detection element for detecting whether a fault is in either a forward or reverse protection zone.

7. The system for distinguishing between a single-phase-to-ground fault and a double-phase-to-ground fault of claim 6, wherein the fault detector is a mho type fault detector.

8. The system for distinguishing between a single-phase-to-ground fault and a double-phase-to-ground fault of claim 1, further comprising a phase detection fault-type selection element in communicating relation with the power swing fault-type selection element for detecting a phase A-to-ground, phase B-to ground, or a phase C-to ground fault.

9. The system for distinguishing between a single-phase-to-ground fault and a double-phase-to-ground fault of claim 1, further comprising a subtraction element for calculating the difference between integral values of the first and second integrator, wherein a power swing fault-type signal is asserted based on the difference value.

10. The system for distinguishing between a single-phase-to-ground fault and a double-phase-to-ground fault of claim 9, further comprising a first and second selected threshold, wherein a power swing fault-type signal is asserted when the difference value reaches the first threshold and another power swing fault-type signal is asserted when the difference value reaches the second threshold.

11. A system for distinguishing between a single-phase-to-ground fault and a double-phase-to-ground fault, comprising:
a distance value computation element for determining a first distance value for a first fault distance trajectory and a second distance value for a second fault distance trajectory,
a power swing fault-type selection element in communicating relation with said distance value computation element including a first integrator for determining an integral value of the difference between a first latched value of the distance value and the first fault distance trajectory, wherein the first latched value is determined at a rising edge of a detected fault, and a second integrator for determining an integral value of the difference between a second latched value of the distance value and the second fault distance trajectory, wherein the second latched value is determined at a rising edge of a second detected fault, and
a fault detector in communicating relation with said fault-type selection element for detecting both a forward and reverse protection zone.

12. The system for distinguishing between a single-phase-to-ground fault and a double-phase-to-ground fault of claim 11, further comprising an out-of-step detection element in communicating relation with the power swing fault-type selection element for detecting an out-of-step condition.

13. The system for distinguishing between a single-phase-to-ground fault and a double-phase-to-ground fault of claim 11, further comprising an out-of-step blocking element in communicating relation with the power swing fault-type selection element for blocking a tripping signal.

14. The system for distinguishing between a single-phase-to-ground fault and a double-phase-to-ground fault of claim 11, wherein the fault detector is a mho type fault detector.

15. The system for distinguishing between a single-phase-to-ground fault and a double-phase-to-ground fault of claim 11, further comprising a phase detection fault-type selection element in communicating relation with the power swing fault-type selection element for detecting a phase A-to-ground, phase B-to ground, or a phase C-to ground fault.

16. The system for distinguishing between a single-phase-to-ground fault and a double-phase-to-ground fault of claim 11, further comprising a subtraction element for calculating a difference value between the integral values of the first and second integrator, wherein a power swing fault-type signal is asserted based on the difference value.

17. The system for distinguishing between a single-phase-to-ground fault and a double-phase-to-ground fault of claim 16, further comprising a first and second selected threshold, a power swing fault-type signal is asserted when the difference value reaches the first threshold and another power swing fault-type signal is asserted when the difference value reaches the second threshold.

18. A method for distinguishing between a single-phase-to-ground fault and double-phase-to-ground fault, comprising:
determining a first distance value for a first fault distance trajectory and a second distance value for a second fault distance trajectory,
determining an integral value between the difference of a first latched value of the distance value and the first fault distance trajectory, wherein the first latched value is determined at a rising edge of a detected fault, and
determining an integral value of the difference between a second latched value of the distance value and the second fault distance trajectory, wherein the second latched value is determined at a rising edge of a second detected fault.

19. The method for distinguishing between a single-phase-to-ground fault and a double-phase-to-ground fault of claim 18, further comprising calculating a difference value between integral values of the first and second integrator, and asserting a power swing fault-type signal based on the difference value.

20. The method for distinguishing between a single-phase-to-ground fault and a double-phase-to-ground fault of claim 19, further comparing the difference value with a first and second threshold, and asserting a power swing fault-type signal when the difference value reaches the first threshold and asserting another power swing fault-type signal when the difference value reaches the second threshold.

21. A system for distinguishing between a single-phase-to-ground fault and a double-phase-to-ground fault, comprising:
a distance value computation element for determining a first distance value for a first fault distance trajectory and a second distance value for a second fault distance trajectory,
a power swing fault-type selection element including a first derivative element for determining a rate of change value for the first fault distance trajectory, and a second derivative element for determining a rate of change value for the second fault distance trajectory.

22. The system for distinguishing between a single-phase-to-ground fault and a double-phase-to-ground fault of claim 21, further comprising an out-of-step detection element in communicating relation with the power swing fault-type selection element for detecting an out-of-step condition.

23. The system for distinguishing between a single-phase-to-ground fault and a double-phase-to-ground fault of claim 21, further comprising an out-of-step blocking element in communicating relation with the power swing fault-type selection element for blocking a tripping signal.

24. The system for distinguishing between a single-phase-to-ground fault and a double-phase-to-ground fault of claim 21, further comprising a fault detector in communicating relation with said power swing fault-type selection element for detecting whether a fault is in either a forward or reverse protection zone.

25. The system for distinguishing between a single-phase-to-ground fault and a double-phase-to-ground fault of claim 24, wherein the fault detector is a mho type fault detector.

26. The system for distinguishing between a single-phase-to-ground fault and a double-phase-to-ground fault of claim 21, further comprising a phase detection fault-type selection element in communicating relation with the power swing fault-type selection element for detecting a phase A-to-ground, phase B-to ground, or a phase C-to ground fault.

27. The system for distinguishing between a single-phase-to-ground fault and a double-phase-to-ground fault of claim 21, further comprising a first and second selected threshold, wherein a power swing fault-type signal is asserted when either rate of change value the first threshold and another power swing fault-type signal is asserted when either rate of change value reaches the second threshold.
